(19) United States
(12) Patent Application Publication
(10) Pub. No.: US 2026/0159167 A1
(43) Pub. Date: Jun. 11, 2026

(54) VEHICLE SKELETON STRUCTURE

(71) Applicant: TOYOTA JIDOSHA KABUSHIKI KAISHA, Toyota-shi (JP)

(72) Inventors: Kohei NODA, Toyota-shi (JP); Shigenori HASHIDA, Nisshin-shi (JP)

(73) Assignee: TOYOTA JIDOSHA KABUSHIKI KAISHA, Toyota-shi (JP)

(21) Appl. No.: 19/404,418

(22) Filed: Dec. 1, 2025

(30) Foreign Application Priority Data
Dec. 6, 2024 (JP) 2024-213863

(51) Int. Cl. B62D 21/11

(52) U.S. Cl. CPC B62D 21/11

(57) ABSTRACT

A vehicle skeleton structure includes a skeleton body including a wheel house part and formed integrally by casting, and a pair of through-hole reinforcing ribs disposed so as to sandwich a through-hole formed in the skeleton body in a vehicle front-rear direction, each of the ribs extending in a vehicle vertical direction and being formed integrally with the skeleton body.

### CROSS-REFERENCE TO RELATED APPLICATION

This application is based on and claims priority under 35 USC 119 from Japanese Patent Application No. 2024-213863 filed on December 6, 2024, the disclosure of which is incorporated by reference herein.

### BACKGROUND

### Technical Field

The present disclosure relates to a vehicle skeleton structure.

### Related Art

Japanese Patent Application Laid-Open (JP-A) No. 2020-44977 discloses a suspension housing formed by aluminum die casting, the suspension housing being fixed to a front frame and a skeleton member, such as an apron reinforcement, so as to cover an area above a wheel house.

However, in structures in which a skeleton including a wheel house of a vehicle is formed by casting, as described in JP-A No. 2020-44977, in cases in which through-holes are formed in a skeleton, it is common to form the through-holes by machining after casting. However, there are cases in which the periphery of a machined portion is deformed when the through hole is formed.

### SUMMARY

The present disclosure provides a vehicle skeleton structure capable of suppressing deformation around a through hole in a skeleton formed by casting.

A vehicle skeleton structure of a first aspect includes: a skeleton body including a wheel house part and formed integrally by casting; and a pair of through-hole reinforcing ribs disposed so as to sandwich a through-hole formed in the skeleton body in a vehicle front-rear direction, each of the ribs extending in a vehicle vertical direction and being formed integrally with the skeleton body.

In the vehicle skeleton structure of the first aspect, a skeleton body is integrally formed by casting including a wheel house part, and a through-hole is formed in the skeleton body. A pair of through-hole reinforcing ribs are formed at the skeleton body so as to sandwich the through-hole in the vehicle front-rear direction. Here, the through-hole reinforcing ribs each extend in the vehicle up-down direction, and are integrally formed with the skeleton body. This enables the periphery of the through-hole to be effectively reinforced.

A vehicle skeleton structure of a second aspect is the first aspect, in which the through-hole is formed in a region of the wheel house that is enclosed by plural ridge lines, and the through-hole reinforcing ribs span between the ridge lines.

In the vehicle skeleton structure of the second aspect, by having the through-hole reinforcing ribs span between the ridge lines, the periphery of the through-hole can be reinforced more effectively.

A vehicle skeleton structure of a third aspect is the first aspect, in which an inclined face, inclined towards a vehicle width direction outer side on progression from a vehicle lower side to a vehicle upper side, is formed at an upper end part of the wheel house part, and the through-hole and the through-hole reinforcing ribs are formed at the inclined face.

In the vehicle skeleton structure of the third aspect, even in a case in which the through-hole is formed in an inclined face, which tends to have insufficient strength, material shortage in the vicinity of the through-hole can be suppressed.

A vehicle skeleton structure of a fourth aspect is the third aspect, in which plural lower part reinforcing ribs are provided along the vehicle front-rear direction at a lower part of the wheel house part, and the through-hole reinforcing ribs and the lower part reinforcing ribs are connected by coupling ribs extending in the vehicle vertical direction.

In the vehicle skeleton structure of the fourth aspect, a load can be transmitted from the through-hole reinforcing ribs to the lower part reinforcing ribs via the coupling ribs.

A vehicle skeleton structure of a fifth aspect is any one of the first to fourth aspects, in which a face of the pair of through-hole reinforcing ribs at a side of the though-hole is inclined in a direction approaching the through-hole from a leading end side to a root end side of the face.

In the vehicle skeleton structure of the fifth aspect, during machining of the through-hole, a machining tool can be guided to the machining position by the ribs.

As explained above, the vehicle skeleton structure according to the present disclosure can suppress deformation around a through-hole in a skeleton formed by casting.

### BRIEF DESCRIPTION OF THE DRAWINGS

Exemplary embodiments of the present disclosure will be described in detail based on the following figures, wherein:

FIG. 1 is a perspective view illustrating relevant parts of a vehicle skeleton structure according to an exemplary embodiment; and

FIG. 2 shows a cross-section taken along line 2-2 in FIG. 1.

### DETAILED DESCRIPTION

Explanation follows regarding a vehicle skeleton structure according to an exemplary embodiment, with reference to the drawings.

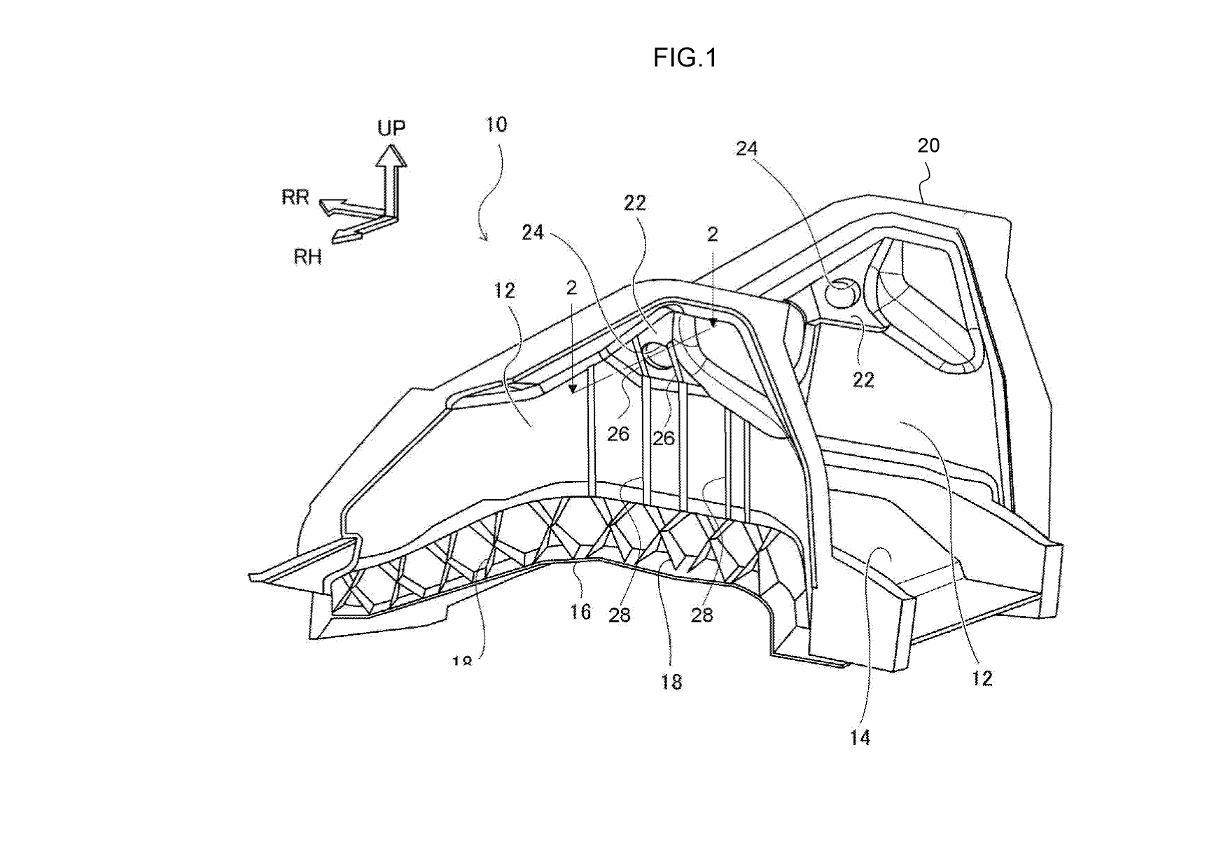

FIG. 1 is a perspective view illustrating relevant parts of a vehicle skeleton structure according to an exemplary embodiment. Note that in the drawings, the arrow RR, the arrow UP, and the arrow RH respectively indicate the vehicle rear direction, the vehicle upper direction, and the vehicle right direction of a vehicle. Unless specifically stated otherwise, in the following explanation, reference to the front and rear, up and down, and left and right directions refers to front and rear in the vehicle front-rear direction, up and down in the vehicle up-down direction, and left and right in the vehicle left-right direction (width direction), respectively.

As illustrated in FIG. 1, a skeleton body 10 configuring the vehicle skeleton structure is a component that is disposed at the rear part of a vehicle, that includes a wheel house part 12, and that is formed by casting. Note that in the present exemplary embodiment, explanation is given regarding a case in which a vehicle skeleton structure is applied to a rear part of a vehicle; however, there is no limitation to this, and it may be applied to the front part of a vehicle. In such cases, the vehicle skeleton structure is integrally formed by casting, including the wheel house at the front side.

A left and right pair of wheel house parts 12 are provided, each extending in the vehicle front-rear direction and in the vehicle up-down direction. Lower end parts of the left and right wheel house parts 12 are connected in the vehicle width direction by a rear panel part 14.

A rear side member part 16 extending in the vehicle front-rear direction is provided at a lower end part of the wheel house part 12. The rear side member part 16 is integrally formed by casting together with the wheel house part 12, and plural lower part reinforcing ribs 18 are formed along the vehicle front-rear direction at a vehicle width direction outer side face of the rear side member part 16.

Plural lower part reinforcing ribs 18 are formed along the vehicle front-rear direction, and each is formed in a substantial X-shape when viewed from the vehicle width direction.

Note that the outer edge of the wheel house part 12 is formed in a substantial arch shape in which a vehicle front-rear direction center portion bulges toward a vehicle upper side when viewed from the vehicle width direction, and a flange part 20 is provided along an upper edge of the wheel house part 12.

The flange part 20 is provided at the entire area of the outer edge of the wheel house part 12, and extends toward the vehicle upper side from an outer edge of the wheel house part 12. Plural bolt holes, not illustrated in the drawings, are formed in the flange part 20, and bolts are inserted into these bolt holes, whereby peripheral components are fastened to the wheel house part 12.

An inclined face 22 is formed at an uppermost part of the wheel house part 12. The inclined face 22 is formed lower than the flange part 20, and inclines toward the vehicle width direction inner side on progression from the vehicle upper side toward the vehicle lower side. A ridge line is formed between the inclined face 22 and an adjacent face.

A through-hole 24 is formed in the inclined face 22. The through-hole 24 is a circular hole formed so as to perpendicularly penetrate the inclined face 22. Note that in the present exemplary embodiment, as an example, the through-hole 24 is formed by machining after casting, and a harness, a brake wire, a cooling tube or the like, not illustrated in the drawings, is passed through the through-hole 24. Parts at the vehicle outer side and parts at the vehicle inner side are connected by a harness, a brake wire, a cooling tube, or the like through the through-hole 24. Note that the through-hole 24 may be used to pass through a welding gun in an assembly process, and may be used as a service hole for accessing a component such as a bolt.

Through-hole reinforcing ribs 26 are formed at the inclined face 22 of the skeleton body 10. A pair of through-hole reinforcing ribs 26 are provided at the front and rear so as to sandwich the through-hole 24 from the vehicle front-rear direction, and respectively extend in the vehicle up-down direction, and are integrally formed with the skeleton body 10.

The through-hole reinforcing ribs 26 are formed so as to span between ridge lines adjacent to the inclined face 22. Specifically, a lower end of each through-hole reinforcing rib 26 is connected to a ridge line between a face below the inclined face 22 and the inclined face 22, and an upper end of each through-hole reinforcing rib 26 is connected to a ridge line between a face above the inclined face 22 and the inclined face 22.

Coupling ribs 28 are formed between the through-hole reinforcing ribs 26 and the lower part reinforcing ribs 18. Plural coupling ribs 28 are formed at intervals in the vehicle front-rear direction, and each extends in the vehicle up-down direction. In FIG. 1, as an example, five coupling ribs 28 are formed at intervals in the vehicle front-rear direction, but the present disclosure is not limited thereto.

Of the five coupling ribs 28, two coupling ribs 28 are connected to the through-hole reinforcing ribs 26. Specifically, a lower end of the coupling rib 28 is connected to an upper end of the lower part reinforcing rib 18, and an upper end of the coupling rib 28 is connected to a lower end of the through-hole reinforcing rib 26. Thus, the through-hole reinforcing rib 26 and the lower part reinforcing rib 18 are configured in a state coupled in the up-down direction by the coupling rib 28.

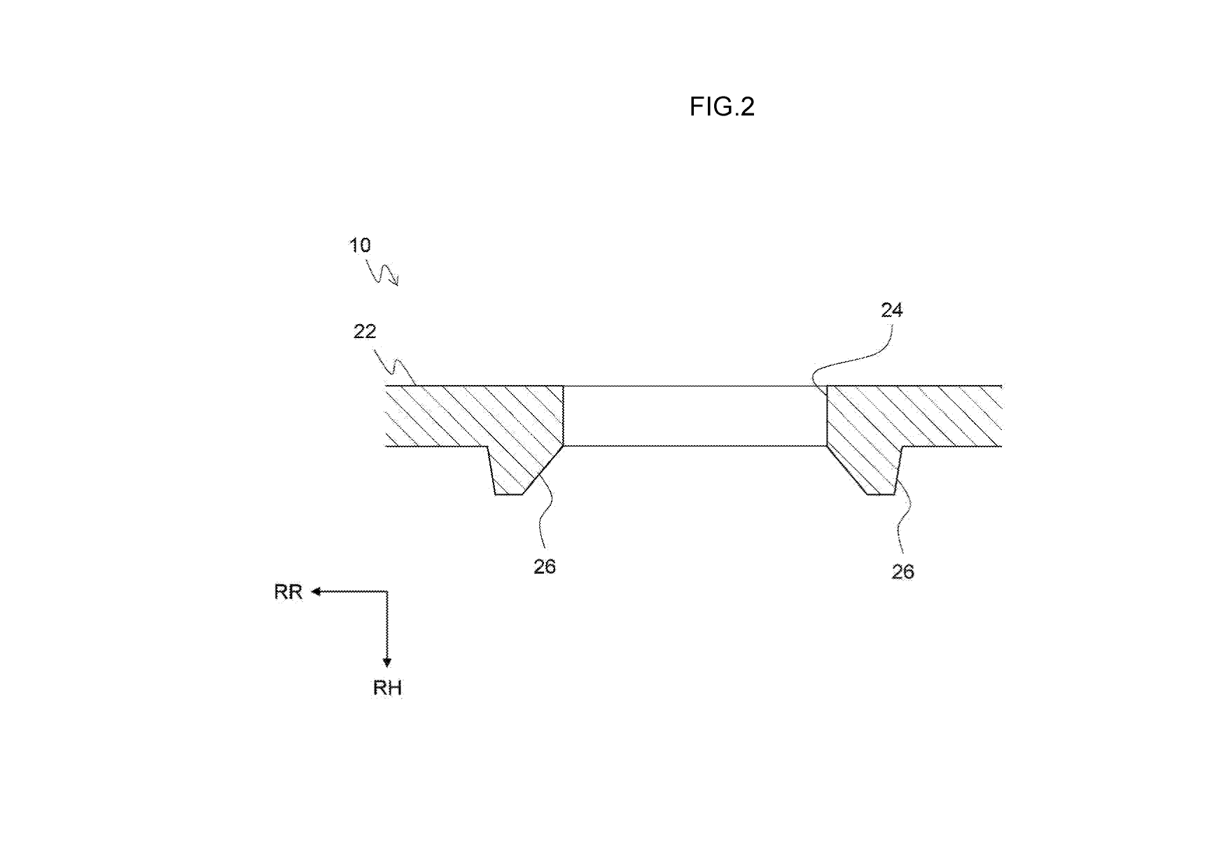

FIG. 2 is a cross-sectional view showing a section along line 2-2 in FIG. 1. As illustrated in FIG. 2, the through-hole reinforcing rib 26 of the present exemplary embodiment has a face at a side of the through-hole 24 that is inclined in a direction sloping toward the through-hole from a leading end side toward a base end.

### Operation

Explanation follows regarding the mechanism of the vehicle skeleton structure according to the present exemplary embodiment.

As illustrated in FIG. 1, in the present exemplary embodiment, the skeleton body 10 is integrally formed by casting, including the wheel house part 12, and a through-hole 24 is formed in the skeleton body 10. A pair of through-hole reinforcing ribs 26 are formed in the skeleton body 10 so as to sandwich the through-hole 24 in the vehicle front-rear direction. Here, the through-hole reinforcing ribs 26 each extend in the vehicle up-down direction, and are integrally formed with the skeleton body 10. This enables the periphery of the through hole 24 to be effectively reinforced. Namely, deformation around the through-hole can be suppressed in a skeleton formed by casting.

Further, in the present exemplary embodiment, by having the through-hole reinforcing ribs 26 span between ridge lines, the periphery of the through-hole 24 can be reinforced more effectively. In particular, in the present exemplary embodiment, the through-hole 24 is formed in an inclined surface 22 that is likely to have insufficient strength, and even in such cases, the through-hole reinforcing ribs 26 can suppress material shortage in the vicinity of the through-hole 24.

In the present exemplary embodiment, the through-hole reinforcing rib 26 and the lower part reinforcing rib 18 are vertically coupled by the coupling rib 28. This enables load to be transmitted from the through-hole reinforcing rib 26 to the lower part reinforcing rib 18 via the coupling rib 28.

Further, in the present exemplary embodiment, since, as illustrated in FIG. 2, the face at the through-hole 24 side of the through-hole reinforcing rib 26 is inclined, during machining of the through-hole 24, the machining tool can be guided to the machining position by the through-hole reinforcing rib 26. Namely, the through-hole reinforcing rib 26 can be used as a guide.

Above, explanation has been given regarding a vehicle skeleton structure according to the present disclosure; however, it is of course the case that various embodiments may be practiced within a range that does not depart from the gist of the present disclosure. For example, in the present exemplary embodiment, the through-hole 24 is formed at the upper end part of the wheel house part 12; however, there is no limitation to this. For example, a through-hole may be formed in a center part of the wheel house part 12, and through-hole reinforcing ribs may be formed so as to sandwich the through-hole.

In the present exemplary embodiment, plural lower part reinforcing ribs 18 are formed along the vehicle front-rear direction at the lower part of the wheel house part 12; however, there is no limitation to this. For example, without providing the lower part reinforcing ribs 18, the coupling ribs 28 may extend from the through-hole reinforcing ribs 26 to the lower end of the skeleton body 10. In such cases, too, a load input at the vicinity of the through-hole 24 can be borne at the lower part of the skeleton body 10 via the coupling ribs 28.

In the present exemplary embodiment, the lower part reinforcing rib 18 is formed in a substantial X-shape in a vehicle side view; however, there is no limitation to this, and other shapes may be employed. For example, the lower part reinforcing ribs may be formed in a substantial grid shape in a vehicle side view.

In relation to the foregoing exemplary embodiment, the following additional notes are disclosed.

### Additional note 1

A vehicle skeleton structure includes:

a skeleton body including a wheel house part and formed integrally by casting; and

a pair of through-hole reinforcing ribs disposed so as to sandwich a through-hole formed in the skeleton body in a vehicle front-rear direction, each of the ribs extending in a vehicle vertical direction and being formed integrally with the skeleton body.

### Additional note 2

The vehicle skeleton structure of additional note 1, in which:

the through-hole is formed in a region of the wheel house that is enclosed by plural ridge lines, and

the through-hole reinforcing ribs span between the ridge lines.

### Additional note 3

The vehicle skeleton structure of additional note 1 or 2, in which:

an inclined face, inclined towards a vehicle width direction outer side on progression from a vehicle lower side to a vehicle upper side, is formed at an upper end part of the wheel house part, and

the through-hole and the through-hole reinforcing ribs are formed at the inclined face.

### Additional note 4

A vehicle skeleton structure according to any one of additional notes 1 to 3, in which:

plural lower part reinforcing ribs are provided along the vehicle front-rear direction at a lower part of the wheel house part, and

the through-hole reinforcing ribs and the lower part reinforcing ribs are connected by coupling ribs extending in the vehicle vertical direction.

### Additional note 5

The vehicle skeleton structure of any one of additional notes 1 to 4, in which a face of the pair of through-hole reinforcing ribs at a side of the though-hole is inclined in a direction approaching the through-hole from a leading end side to a root end side of the face.

What is claimed is:

1. A vehicle skeleton structure, comprising:
a skeleton body including a wheel house part and formed integrally by casting; and
a pair of through-hole reinforcing ribs disposed so as to sandwich a through-hole formed in the skeleton body in a vehicle front-rear direction, each of the ribs extending in a vehicle vertical direction and being formed integrally with the skeleton body.

2. The vehicle skeleton structure of claim 1, wherein:
the through-hole is formed in a region of the wheel house that is enclosed by a plurality of ridge lines, and
the through-hole reinforcing ribs span between the ridge lines.

3. The vehicle skeleton structure of claim 1, wherein:
an inclined face, inclined towards a vehicle width direction outer side on progression from a vehicle lower side to a vehicle upper side, is formed at an upper end part of the wheel house part, and
the through-hole and the through-hole reinforcing ribs are formed at the inclined face.

4. The vehicle skeleton structure of claim 3, wherein:
a plurality of lower part reinforcing ribs are provided along the vehicle front-rear direction at a lower part of the wheel house part, and
the through-hole reinforcing ribs and the lower part reinforcing ribs are connected by coupling ribs extending in the vehicle vertical direction.

5. The vehicle skeleton structure of claim 1, wherein a face of the pair of through-hole reinforcing ribs at a side of the though-hole is inclined in a direction approaching the through-hole from a leading end side to a root end side of the face.
